(19) United States
(12) Patent Application Publication
(10) Pub. No.: US 2024/0276268 A1
(43) Pub. Date: Aug. 15, 2024

(54) PRE-MG ACTIVATION/DEACTIVATION PROCEDURE OVERLAPPING WITH AN OCCASION OF CONCURRENT MG

(71) Applicant: MediaTek Singapore Pte. Ltd., Singapore (SG)

(72) Inventors: Waseem Hazim Ozan Ozan, Cambridge (GB); Tsang-Wei S Aleabe yu, Hsinchu (TW); Hsuan-Li Lin, Hsinchu (TW)

(21) Appl. No.: 18/432,249

(22) Filed: Feb. 5, 2024

Related U.S. Application Data
(60) Provisional application No. 63/485,013, filed on Feb. 15, 2023.
(60) Provisional application No. 63/515,140, filed on Jul. 24, 2023.

(51) Int. Cl. H04W 24/10

(52) U.S. Cl. CPC H04W 24/10

(57) ABSTRACT

In an aspect of the disclosure, a method, a computer-readable medium, and an apparatus are provided. The method may be performed by a UE. In certain configurations, the UE performs a procedure resulting in a status change of a first pre-configured measurement gap (pre-MG) of a pre-MG activation procedure. The UE determines whether the pre-MG activation procedure collides with or is overlapped with an overlapping gap. In response to determining that the pre-MG activation procedure collides with or is overlapped with the overlapping gap, the UE configures a pre-MG activation delay for the first pre-MG after an end of the overlapping gap, and performs the pre-MG activation procedure in the first pre-MG after the pre-MG activation delay.

### CROSS-REFERENCE TO RELATED APPLICATION(S)

This application claims the benefits of U.S. Provisional Application Serial No. 63/485,013, entitled “PRE-MG ACTIVATION/DEACTIVATION PROCEDURE OVERLAPPING WITH AN OCCASION OF CONCURRENT MG” and filed on Feb. 15, 2023, and U.S. Provisional Application Serial No. 63/515,140, entitled “PRE-MG ACTIVATION/DEACTIVATION PROCEDURE OVERLAPPING WITH AN OCCASION OF CONCURRENT GAPS” and filed on Jul. 24, 2023, which are expressly incorporated by reference herein in their entireties.

### BACKGROUND

### Field

The present disclosure relates generally to communication systems, and more particularly, to techniques of methods and apparatuses for performing a pre-configured measurement gap (pre-MG) activation/deactivation procedure overlapping with an occasion of concurrent MG.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The method may be performed by a UE. In certain configurations, the UE performs a procedure resulting in a status change of a first pre-configured measurement gap (pre-MG) of a pre-MG activation procedure. The UE determines whether the pre-MG activation procedure collides with or is overlapped with an overlapping gap. In response to determining that the pre-MG activation procedure collides with or is overlapped with the overlapping gap, the UE configures a pre-MG activation delay for the first pre-MG after an end of the overlapping gap, and performs the pre-MG activation procedure in the first pre-MG after the pre-MG activation delay.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating an example procedure of a UE performing a pre-MG activation/deactivation procedure overlapping with an occasion of concurrent MG.

FIG. 8 is a diagram illustrating an example procedure of a UE determining that a pre-MG activation/deactivation procedure collides with or is overlapped with an occasion of concurrent MG.

FIG. 9 is a diagram illustrating an example procedure of a UE delaying the pre-MG activation/deactivation procedure overlapping with an occasion of concurrent MG upon a DCI/timer-based BWP switching procedure.

FIG. 10 is a diagram illustrating an example procedure of a UE delaying the pre-MG activation/deactivation procedure overlapping with an occasion of concurrent MG upon a SCell activation/deactivation procedure.

FIG. 11 is a diagram illustrating an example procedure of a UE delaying the pre-MG activation/deactivation procedure overlapping with an occasion of concurrent MG upon a RRC reconfiguration procedure.

FIG. 12 is a flow chart of a method (process) for wireless communication of a UE.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

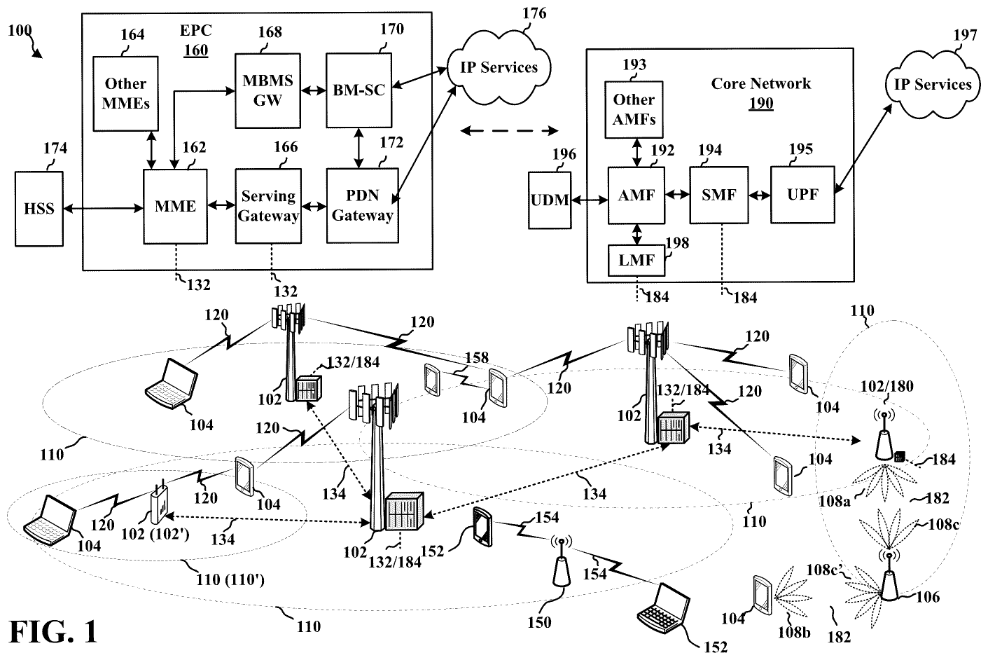

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

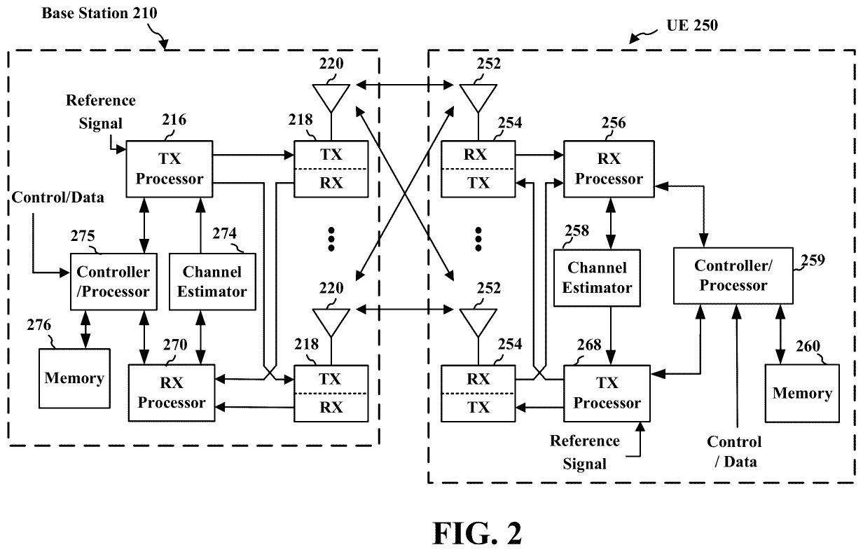

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service.

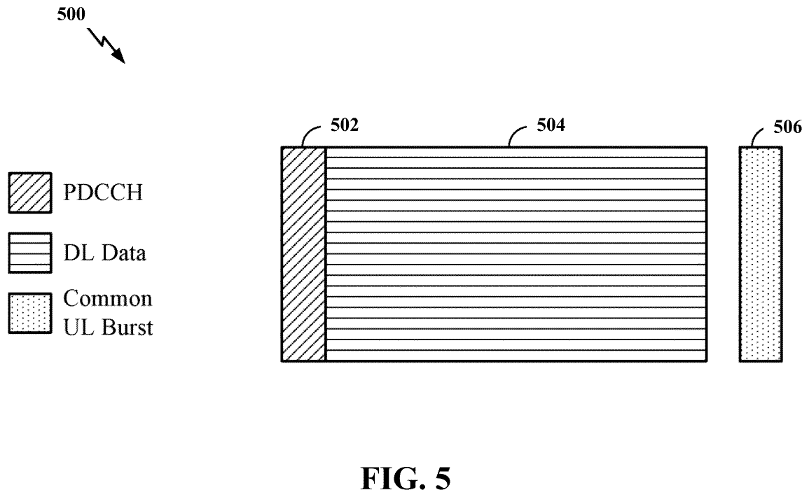

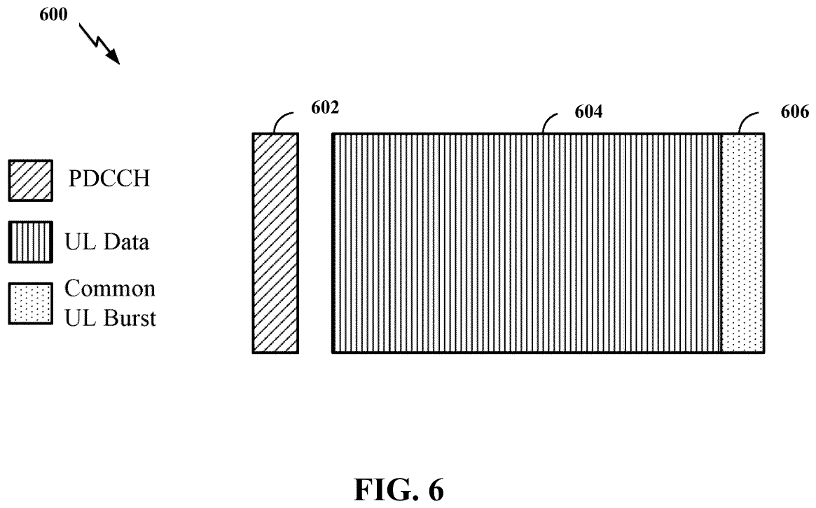

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

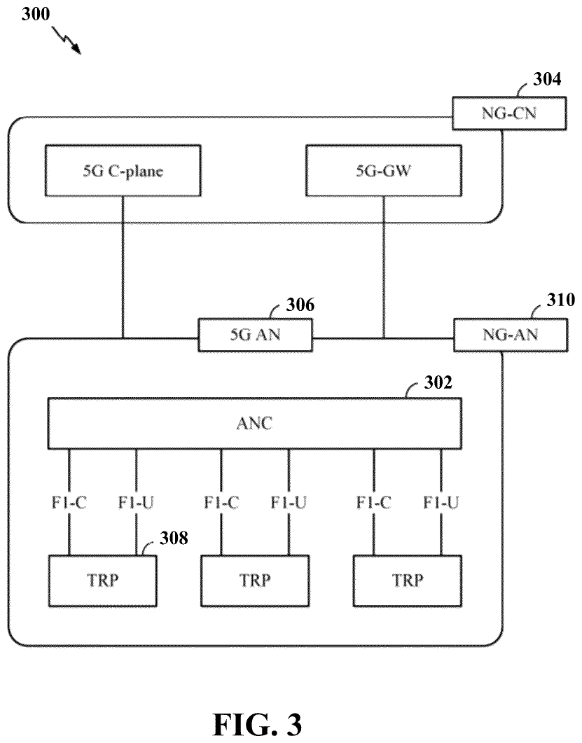

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

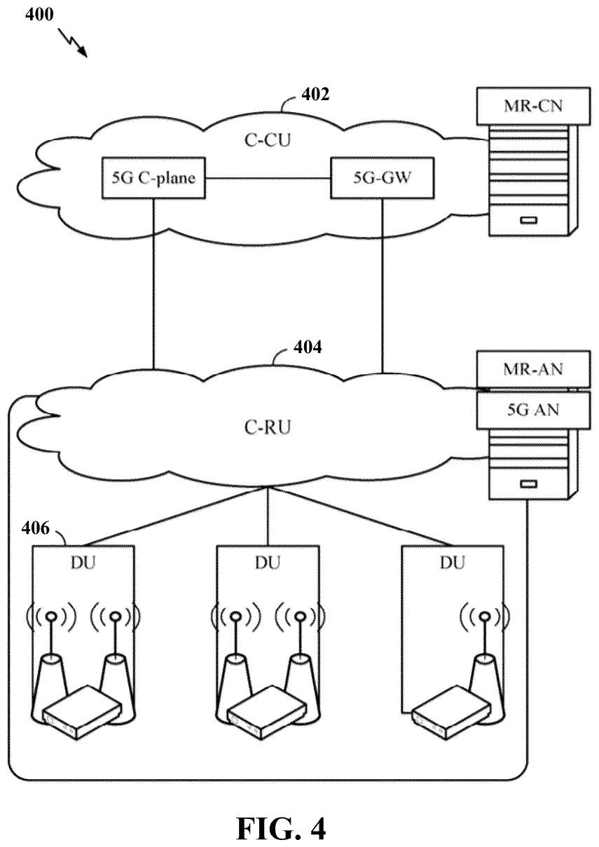

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

In some circumstances, the UE needs measurement gaps to perform measurements when it cannot measure the target carrier frequency while simultaneously transmitting or receiving on the serving cell. For example, the UE may need measurement gaps in order to perform inter-frequency and/or inter-RAT measurements. In certain configurations, it is possible that the UE may have concurrent measurement gaps (con-MGs), which are multiple measurement gaps that allows multiple measurements to be configured concurrently for the UE. When concurrent MGs exist, each gap pattern could be associated with one or multiple frequency layers, where each frequency layer may be associated with only one of the concurrent MGs. In certain configurations, a pre-configured measurement gap (pre-MG) may be provided, which is per-bandwidth part (BWP) activated (e.g., when the UE needs the gap) or deactivated (e.g., when the UE no longer needs the gap). In certain configurations, a measurement gap may be assigned with a priority, such that when one measurement gap has a higher priority than another concurrent measurement gap, the UE may choose to drop the concurrent measurement gap with a lower priority.

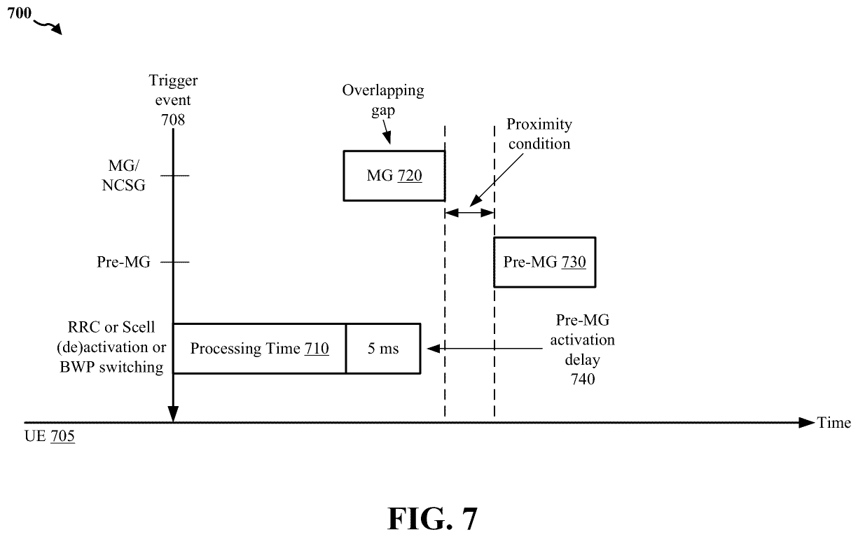

FIG. 7 is a diagram illustrating an example procedure of a UE performing a pre-MG activation/deactivation procedure overlapping with an occasion of concurrent MG. As shown in FIG. 7, in 5G NR the scenario of the pre-MG, when a trigger event 708 occurs, the UE 705 performs a procedure, such as a BWP switching procedure, a SCell activation/deactivation procedure or a RRC reconfiguration procedure, in response to the trigger event 708. Then, the UE 705 may initially pre-configure a pre-MG activation delay 740 (which may also be referred to as an “initial pre-configured activation delay”) for a pre-MG 730 of a pre-MG activation procedure after the processing time 710 of the procedure (i.e., after the processing time of the active BWP switching, or the completion of SCell(s) activation/deactivation, or the completion of RRC processing delay). In certain configurations, the pre-MG activation delay 740 may be 5 ms, allowing the UE 705 to finish the pre-configured activation (or deactivation) with the 5 ms period of the pre-MG activation delay 740 after the end of the processing time 710 of the procedure.

Simultaneously, as shown in FIG. 7, there is an overlapping gap 720, which may be a measurement gap without a priority or frequency association (such as a Release-15 MG or a Release-16 MG), a concurrent measurement gap (con-MG), a network controlled small gap (NCSG), or another activated pre-MG. In this case, a collision case may exist such that the overlapping gap 720 collides with or is overlapped with the pre-MG activation procedure to be performed in the pre-MG 730. For example, the collision case may occur when the pre-MG activation delay 740 ends within an occasion/instance of the overlapping gap 720, or when the start of the pre-MG 730 may be within a proximity condition after completion of the overlapping gap 720. In certain configurations, the proximity condition may occur when the start of the pre-MG 730 is within 5 ms (e.g., 4 ms or a shorter time) after the completion of the overlapping gap 720.

As discussed, when the collision case occurs, one potential solution is to drop the overlapping gap with a lower priority to avoid the collision. For example, when the overlapping gap 720 is another activated pre-MG and the pre-MG 730 has a higher priority than the overlapping gap 720, the UE 705 may choose to drop the overlapping MG 720 with the lower priority. However, this may result in loss in some throughput and measurements. Therefore, an aspects of the disclosure is to introduce a mechanism to delay the pre-MG activation procedure for the pre-MG 830 overlapping with the occasion of the concurrent MG 720 in order to avoid the loss in the throughput and measurements.

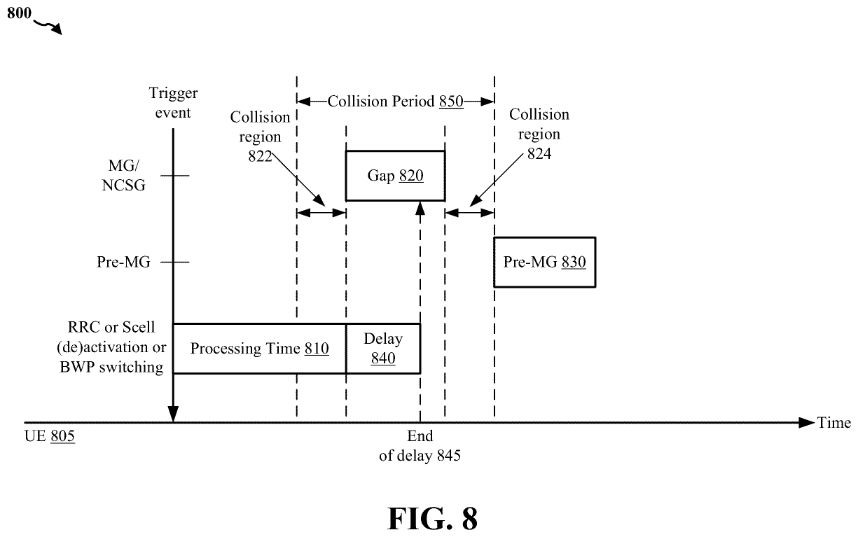

FIG. 8 is a diagram illustrating an example procedure of a UE determining that a pre-MG activation/deactivation procedure collides with or is overlapped with an occasion of concurrent MG. Specifically, in one embodiment, the definition of a collision case may be determined based on the end of the initial pre-configured activation delay. As shown in FIG. 8, when the overlapping gap is a MG or a NCSG, a collision period 850 may be determined for the occasion/instance of the overlapping gap 820 as a period between a first collision region 822 before a start of the overlapping gap 820 and a second collision region 824 after the end of the overlapping gap 820. Specifically, each of the first collision region 822 and the second collision region 824 may be 5 ms. In other words, the collision period 850 is defined as the period between 5 ms before a start of the overlapping gap and 5 ms after the end of the overlapping gap 820. Thus, the UE 805 may determine pre-MG activation procedure based on whether the end 845 of the initial pre-configured activation delay 840 is within the collision period 850. As shown in FIG. 8, when the end 845 of the initial pre-configured activation delay 840 is within the collision period 850, the UE 805 may determine that the pre-MG activation procedure collides with or is overlapped with the overlapping gap 820. On the other hand, when the timing of the overlapping gap 820 changes such that the end 845 of the initial pre-configured activation delay 840 is not within the collision period 850 of the changed gap, the UE 805 may determine that the pre-MG activation procedure does not collide with or is not overlapped with the changed gap.

In the example procedure 800 as shown in FIG. 8, the collision case is determined based on the end of the initial pre-configured activation delay 840 corresponding to the collision period 850 of the overlapping gap 820. In certain configuration, the collision case may be determined based on the initial pre-configured activation delay 840 and the start and the end of the overlapping gap 820. For example, the UE 805 may determine that the pre-MG activation procedure collides with or is overlapped with the overlapping gap 820 when the initial pre-configured activation delay 840 happens less than 5 ms in time before a start of the overlapping gap 820 or when the initial pre-configured activation delay 840 happens less than 5 ms in time after the end of the overlapping gap 820. On the other hand, when the initial pre-configured activation delay 840 happens more than or equal to 5 ms in time before the start of the overlapping gap 820 or when the initial pre-configured activation delay 840 happens more than or equal to 5 ms in time after the end of the overlapping gap 820, the UE 805 may determine that the pre-MG activation procedure does not collide with or is not overlapped with the overlapping gap 820. In this case, there is no need for the UE 805 to calculate a collision period 850 for the overlapping gap 820.

Alternatively, in certain configuration, the collision case may be determined based on the occurrence of a status change of the pre-MG 830 and the start and the end of the overlapping gap 820. For example, the UE 805 may determine that the pre-MG activation procedure collides with or is overlapped with the overlapping gap when the status change of the pre-MG 830 occurs less than 5 ms in time before the start of the overlapping gap 820 or when the status change of the pre-MG 830 occurs less than 5 ms in time after the end of the overlapping gap 820. On the other hand, when the status change of the pre-MG 830 occurs more than or equal to 5 ms in time before the start of the overlapping gap 820 or when the status change of the pre-MG 830 occurs more than or equal to 5 ms in time after the end of the overlapping gap 820, the UE 805 may determine that the pre-MG activation procedure does not collide with or is not overlapped with the overlapping gap 820. In this case, the UE 805 may determine whether the collision case occurs directly based on the occurrence of a status change of the pre-MG 830, regardless of the initial pre-configured activation delay 840 after the processing time 810 of the procedure.

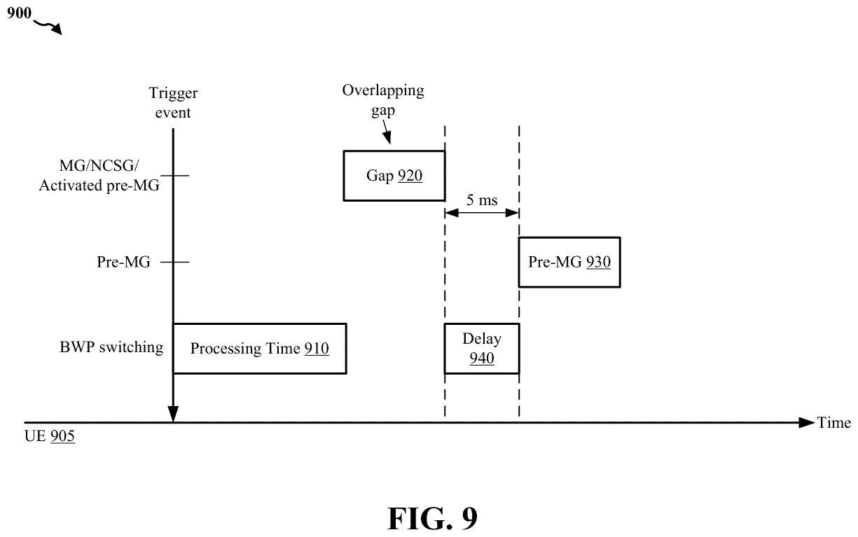

FIG. 9 is a diagram illustrating an example procedure of a UE delaying the pre-MG activation/deactivation procedure overlapping with an occasion of concurrent MG upon a DCI/timer-based BWP switching procedure. In certain configurations, the example procedure 900 applies to the UE 905 when a DCI/timer-based BWP switching procedure is performed on a single CC with more than one BWP configurations configured on the CC. As shown in FIG. 9, when the UE 905 performs the DCI/timer-based BWP switching procedure, the BWP switching procedure may result in a status change of the pre-MG 930 of a pre-MG activation (or deactivation) procedure after the processing time 910 of the BWP switching procedure. Further, the pre-MG activation (or deactivation) procedure collides with or is overlapped with an occasion of an overlapping gap 920, which may be a measurement gap without a priority or frequency association (such as a Release-15 MG or a Release-16 MG), a NCSG, another activated pre-MG or a con-MG (which may be a Release-15/16/17 MG, a pre-MG or a NCSG). Thus, the UE 905 may determine whether the pre-MG activation (or deactivation) procedure collides with or is overlapped with an occasion of the overlapping gap 920. Once the UE 905 determines that the pre-MG activation procedure collides with or is overlapped with the overlapping gap 920, the UE 905 may configure a pre-MG activation delay 940 for the pre-MG 930 after an end of the overlapping gap 920, and then perform the pre-MG activation procedure in the pre-MG 930 after the pre-MG activation delay 940.

As shown in FIG. 9, the pre-MG activation delay 940 may be 5 ms after the completion of the overlapping gap 920, such that the UE 905 ensures the end of the pre-MG activation delay 940 (i.e., the start of the pre-MG 930) and the status change of the pre-MG 930 occur at least 5 ms after the completion of the overlapping gap 920, thus avoiding the collision case. In this case, the earliest time the pre-MG 930 may be activated (or deactivated) is 5 ms after the end of the overlapping gap 920, regardless of the value of the initial pre-MG activation/deactivation delay (e.g., the initial pre-configured activation delay 840) for the pre-MG 930. In certain configurations, the pre-MG activation delay 940 may be a period longer than 5 ms. For example, in one embodiment, the pre-MG activation delay 940 may be up to 10 ms.

In certain configurations, since the UE 905 configures the pre-MG activation delay 940 for the pre-MG activation (or deactivation) procedure, there is no collision between the pre-MG activation (or deactivation) procedure and the overlapping gap 920. Thus, the UE 905 may continue performing measurements in the overlapping gap 920. In certain configurations, when the UE 905 determines that collision occurs, it is up to the UE implementation on whether the UE 905 continues performing measurements in the overlapping gap 920.

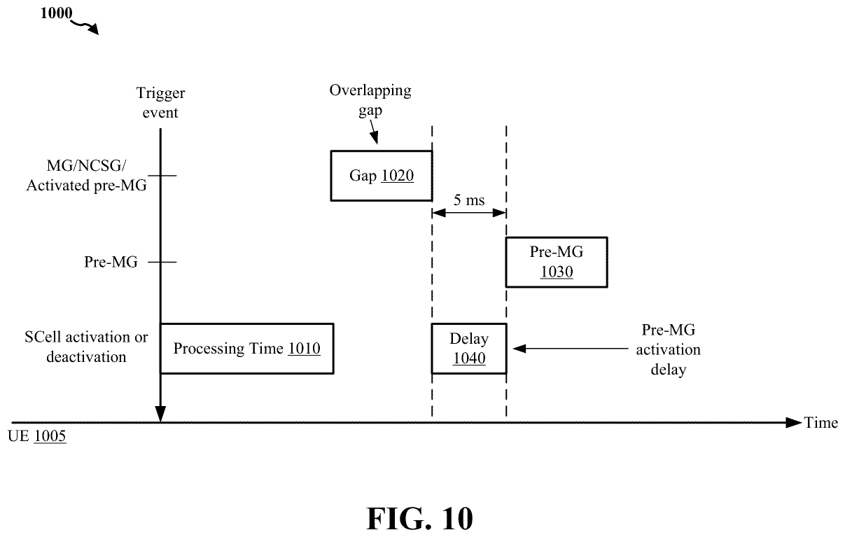

FIG. 10 is a diagram illustrating an example procedure of a UE delaying the pre-MG activation/deactivation procedure overlapping with an occasion of concurrent MG upon a SCell activation/deactivation procedure. In certain configurations, the example procedure 1000 applies to the UE 1005 when one SCell or multiple SCells are activated/deactivated. As shown in FIG. 10, when the UE 1005 performs the SCell activation/deactivation procedure, the SCell activation/deactivation procedure may result in a status change of the pre-MG 1030 of a pre-MG activation (or deactivation) procedure after the processing time 1010 of the SCell activation/deactivation procedure. Further, similar to FIG. 9, the pre-MG activation (or deactivation) procedure collides with or is overlapped with an occasion of an overlapping gap 1020, which may be a measurement gap without a priority or frequency association (such as a Release-15 MG or a Release-16 MG), a NCSG, another activated pre-MG or a con-MG (which may be a Release-15/16/17 MG, a pre-MG or a NCSG). Thus, the UE 1005 may determine whether the pre-MG activation (or deactivation) procedure collides with or is overlapped with an occasion of the overlapping gap 1020. Once the UE 1005 determines that the pre-MG activation procedure collides with or is overlapped with the overlapping gap 1020, the UE 1005 may configure a pre-MG activation delay 1040 for the pre-MG 1030 after an end of the overlapping gap 1020, and then perform the pre-MG activation procedure in the pre-MG 1030 after the pre-MG activation delay 1040.

In certain configurations, the pre-MG activation delay 1040 may be 5 ms after the completion of the overlapping gap 1020, such that the UE 1005 ensures the end of the pre-MG activation delay 1040 (i.e., the start of the pre-MG 1030) and the status change of the pre-MG 1030 occur at least 5 ms after the completion of the overlapping gap 1020, thus avoiding the collision case. In this case, the earliest time the pre-MG 1030 may be activated (or deactivated) is 5 ms after the end of the overlapping gap 1020, regardless of the value of the initial pre-MG activation/deactivation delay (e.g., the initial pre-configured activation delay 840) for the pre-MG 1030. In certain configurations, the pre-MG activation delay 1040 may be a period longer than 5 ms. For example, in one embodiment, the pre-MG activation delay 1040 may be up to 10 ms.

As shown in FIG. 10, since the UE 1005 configures the pre-MG activation delay 1040 for the pre-MG activation (or deactivation) procedure, there is no collision between the pre-MG activation (or deactivation) procedure and the overlapping gap 1020. Thus, the UE 1005 may continue performing measurements in the overlapping gap 1020. In certain configurations, when the UE 1005 determines that collision occurs, it is up to the UE implementation on whether the UE 1005 continues performing measurements in the overlapping gap 1020.

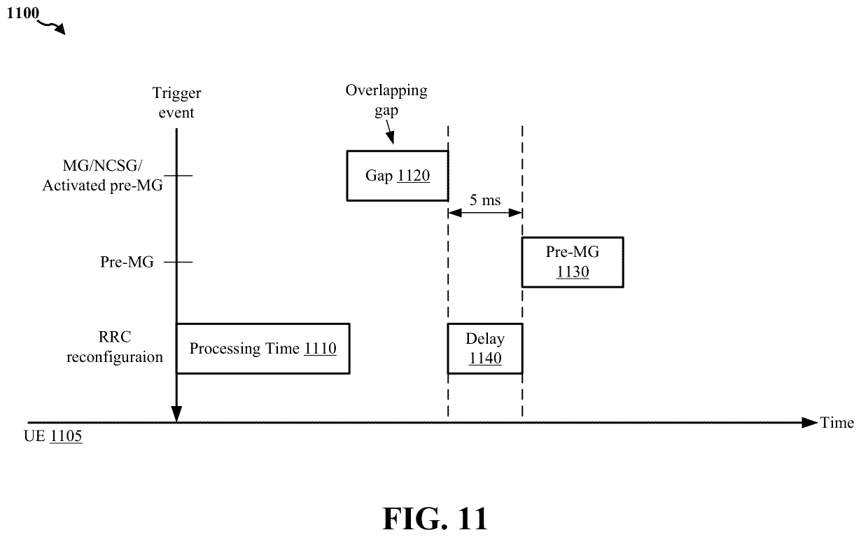

FIG. 11 is a diagram illustrating an example procedure of a UE delaying the pre-MG activation/deactivation procedure overlapping with an occasion of concurrent MG upon a RRC reconfiguration procedure. In certain configurations, the example procedure 1100 applies to the UE 1105 when the UE 1105 is capable of performing an autonomous activation/deactivation mechanism and receives a RRC reconfiguration to add or remove any measurement object(s), to add/release/change a SCell under CA, or to switch an active BWP or update parameters of the active BWP. As shown in FIG. 11, when the UE 1105 performs the RRC reconfiguration procedure, the RRC reconfiguration procedure may result in a status change of the pre-MG 1130 of a pre-MG activation (or deactivation) procedure after the processing time 1110 of the SCell activation/deactivation procedure. Further, similar to FIG. 9 and FIG. 10, the pre-MG activation (or deactivation) procedure collides with or is overlapped with an occasion of an overlapping gap 1120, which may be a measurement gap without a priority or frequency association (such as a Release-15 MG or a Release-16 MG), a NCSG, another activated pre-MG or a con-MG (which may be a Release-15/16/17 MG, a pre-MG or a NCSG). Thus, the UE 1105 may determine whether the pre-MG activation (or deactivation) procedure collides with or is overlapped with an occasion of the overlapping gap 1120. Once the UE 1105 determines that the pre-MG activation procedure collides with or is overlapped with the overlapping gap 1120, the UE 1105 may configure a pre-MG activation delay 1140 for the pre-MG 1130 after an end of the overlapping gap 1120, and then perform the pre-MG activation procedure in the pre-MG 1130 after the pre-MG activation delay 1140.

As shown in FIG. 11, the pre-MG activation delay 1140 may be 5 ms after the completion of the overlapping gap 1120, such that the UE 1105 ensures the end of the pre-MG activation delay 1140 (i.e., the start of the pre-MG 1130) and the status change of the pre-MG 1130 occur at least 5 ms after the completion of the overlapping gap 1120, thus avoiding the collision case. In this case, the earliest time the pre-MG 1130 may be activated (or deactivated) is 5 ms after the end of the overlapping gap 1120, regardless of the value of the initial pre-MG activation/deactivation delay (e.g., the initial pre-configured activation delay 840) for the pre-MG 1130. In certain configurations, the pre-MG activation delay 1140 may be a period longer than 5 ms. For example, in one embodiment, the pre-MG activation delay 1140 may be up to 10 ms.

In certain configurations, since the UE 1105 configures the pre-MG activation delay 1140 for the pre-MG activation (or deactivation) procedure, there is no collision between the pre-MG activation (or deactivation) procedure and the overlapping gap 1120. Thus, the UE 1105 may continue performing measurements in the overlapping gap 1120. In certain configurations, when the UE 1105 determines that collision occurs, it is up to the UE implementation on whether the UE 1105 continues performing measurements in the overlapping gap 1120.

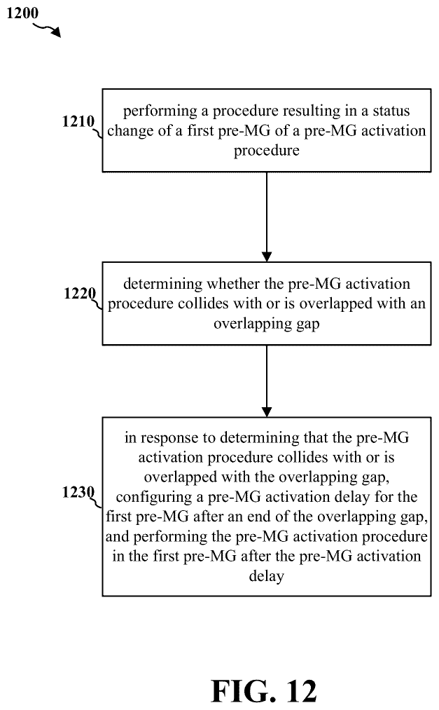

FIG. 12 is a flow chart of a method (process) for wireless communication of a UE. The method may be performed by a UE (e.g., the UE 905, 1005 and/or 1105). At operation 1210, the UE performs a procedure resulting in a status change of a first pre-MG of a pre-MG activation procedure. In certain configurations, the procedure is a BWP switching procedure, a SCell activation/deactivation procedure, or a RRC reconfiguration procedure. At operation 1220, the UE determines whether the pre-MG activation procedure collides with or is overlapped with an overlapping gap. At operation 1230, in response to determining that the pre-MG activation procedure collides with or is overlapped with the overlapping gap, the UE configures a pre-MG activation delay for the first pre-MG after an end of the overlapping gap, and performs the pre-MG activation procedure in the first pre-MG after the pre-MG activation delay.

In certain embodiments, the first pre-MG has an initial pre-configured activation delay, and the pre-MG activation procedure is determined to collide with or to be overlapped with the overlapping gap based on an end of the initial pre-configured activation delay.

In one embodiment, the pre-MG activation procedure is determined to collide with or to be overlapped with the overlapping gap when an end of the initial pre-configured activation delay is within a collision period of the overlapping gap.

In one embodiment, the pre-MG activation procedure is determined to collide with or to be overlapped with the overlapping gap when the initial pre-configured activation delay of the first pre-MG happens within less than or equal to 4 ms in time before a start of the overlapping gap or when the initial pre-configured activation delay of the first pre-MG happens within less than or equal to 4 ms in time after the end of the overlapping gap.

In one embodiment, the pre-MG activation procedure is determined to collide with or to be overlapped with the overlapping gap, and the pre-MG activation procedure is delayed until 5 ms after the end of the overlapping gap.

In one embodiment, the UE is configured to continue measurement within the overlapping gap. In an alternative embodiment, it is up to the UE implementation on whether the UE continues measurement within the overlapping gap. In other words, the UE may, in response to determining that the pre-MG activation procedure collides with or is overlapped with the overlapping gap, determine whether the UE continues measurement within the overlapping gap.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
performing a procedure resulting in a status change of a first pre-configured measurement gap (pre-MG) of a pre-MG activation procedure;
determining whether the pre-MG activation procedure collides with or is overlapped with an overlapping gap; and
in response to determining that the pre-MG activation procedure collides with or is overlapped with the overlapping gap, configuring a pre-MG activation delay for the first pre-MG after an end of the overlapping gap, and performing the pre-MG activation procedure in the first pre-MG after the pre-MG activation delay.

2. The method of claim 1, wherein the procedure is:
a bandwidth part (BWP) switching procedure;
a secondary cell (SCell) activation/deactivation procedure; or
a radio resource control (RRC) reconfiguration procedure.

3. The method of claim 1, wherein the overlapping gap is a measurement gap without a priority or frequency association, a concurrent measurement gap (con-MG), a network controlled small gap (NCSG), or an activated second pre-MG.

4. The method of claim 1, wherein the first pre-MG has an initial pre-configured activation delay, and the pre-MG activation procedure is determined to collide with or to be overlapped with the overlapping gap based on an end of the initial pre-configured activation delay.

5. The method of claim 4, wherein the pre-MG activation procedure is determined to collide with or to be overlapped with the overlapping gap when an end of the initial pre-configured activation delay is within a collision period of the overlapping gap.

6. The method of claim 4, wherein the pre-MG activation procedure is determined to collide with or to be overlapped with the overlapping gap when the initial pre-configured activation delay of the first pre-MG happens within less than or equal to 4 ms in time before a start of the overlapping gap or when the initial pre-configured activation delay of the first pre-MG happens within less than or equal to 4 ms in time after the end of the overlapping gap.

7. The method of claim 1, wherein the pre-MG activation procedure is determined to collide with or to be overlapped with the overlapping gap, and the pre-MG activation procedure is delayed until 5 ms after the end of the overlapping gap.

8. The method of claim 1, wherein the UE is configured to continue measurement within the overlapping gap.

9. The method of claim 1, further comprising:
in response to determining that the pre-MG activation procedure collides with or is overlapped with the overlapping gap, determining whether the UE continues measurement within the overlapping gap.

10. An apparatus for wireless communication, the apparatus being a user equipment (UE), comprising:
a memory; and
at least one processor coupled to the memory and configured to:
perform a procedure resulting in a status change of a first pre-configured measurement gap (pre-MG) of a pre-MG activation procedure;
determine whether the pre-MG activation procedure collides with or is overlapped with an overlapping gap; and
in response to determining that the pre-MG activation procedure collides with or is overlapped with the overlapping gap, configure a pre-MG activation delay for the first pre-MG after an end of the overlapping gap, and perform the pre-MG activation procedure in the first pre-MG after the pre-MG activation delay.

11. The apparatus of claim 10, wherein the procedure is:
a bandwidth part (BWP) switching procedure;
a secondary cell (SCell) activation/deactivation procedure; or
a radio resource control (RRC) reconfiguration procedure.

12. The apparatus of claim 10, wherein the overlapping gap is a measurement gap without a priority or frequency association, a concurrent measurement gap (con-MG), a network controlled small gap (NCSG), or an activated second pre-MG.

13. The apparatus of claim 10, wherein the first pre-MG has an initial pre-configured activation delay, and the pre-MG activation procedure is determined to collide with or to be overlapped with the overlapping gap based on an end of the initial pre-configured activation delay.

14. The apparatus of claim 13, wherein the pre-MG activation procedure is determined to collide with or to be overlapped with the overlapping gap when an end of the initial pre-configured activation delay is within a collision period of the overlapping gap.

15. The apparatus of claim 13, wherein the pre-MG activation procedure is determined to collide with or to be overlapped with the overlapping gap when the initial pre-configured activation delay of the first pre-MG happens within less than or equal to 4 ms in time before a start of the overlapping gap or when the initial pre-configured activation delay of the first pre-MG happens within less than or equal to 4 ms in time after the end of the overlapping gap.

16. The apparatus of claim 10, wherein the pre-MG activation procedure is determined to collide with or to be overlapped with the overlapping gap, and the pre-MG activation procedure is delayed until 5 ms after the end of the overlapping gap.

17. The apparatus of claim 10, wherein the UE is configured to continue measurement within the overlapping gap.

18. The apparatus of claim 10, wherein the at least one processor is further configured to:
in response to determining that the pre-MG activation procedure collides with or is overlapped with the overlapping gap, determine whether the UE continues measurement within the overlapping gap.

19. A computer-readable medium storing computer executable code for performing wireless communication of a user equipment (UE), comprising code to:
perform a procedure resulting in a status change of a first pre-configured measurement gap (pre-MG) of a pre-MG activation procedure;
determine whether the pre-MG activation procedure collides with or is overlapped with an overlapping gap; and
in response to determining that the pre-MG activation procedure collides with or is overlapped with the overlapping gap, configure a pre-MG activation delay for the first pre-MG after an end of the overlapping gap, and perform the pre-MG activation procedure in the first pre-MG after the pre-MG activation delay.

20. The computer-readable medium of claim 19, wherein the procedure is:
a bandwidth part (BWP) switching procedure;
a secondary cell (SCell) activation/deactivation procedure; or
a radio resource control (RRC) reconfiguration procedure.
